(19) United States
(12) Patent Application Publication
(10) Pub. No.: US 2024/0268403 A1
(43) Pub. Date: Aug. 15, 2024

(54) COMPOSITIONS AND METHODS USING IN-SITU COMPLEXATION OF AN EXOGENOUS MINERAL WITH MILK CASEIN IN LIQUID FORM

(71) Applicant: SOCIETE DES PRODUITS NESTLE S.A., Vevey (CH)

(72) Inventors: JOESKA HUSNY, Aarau (CH); BIRGIT HOLST, Jongny (CH); MAGALIE SABATIER, Lausanne 26 (CH)

(21) Appl. No.: 18/292,814

(22) PCT Filed: Jul. 29, 2022
(86) PCT No.: PCT/EP2022/071362

§ 371 Date: Jan. 26, 2024

(30) Foreign Application Priority Data
Jul. 29, 2021 (EP) 21188631.2

(51) Int. Cl. A23C 9/152; A23C 9/158; A23C 9/16

(52) U.S. Cl. CPC A23C 9/1522; A23C 9/158; A23C 9/16

(57) ABSTRACT

A method of in-situ complexation of an exogenous mineral with milk casein in liquid form for fortification in a dairy product with increased bioavailability of the exogenous mineral. The method includes adding exogenous phosphorus and the exogenous mineral to at least one material containing the milk casein, such as a mammalian milk containing the milk casein, to form a composition containing a soluble complex. At least one additional ingredient is present during the adding of the exogenous phosphorus and the exogenous mineral to the at least one material to form the composition containing the soluble complex. The soluble complex contains (i) at least a portion of the exogenous mineral, (ii) at least a portion of the milk casein, and (iii) at least a portion of the exogenous phosphorus; and the soluble complex has micellar structure.

### BACKGROUND

The essential metals (otherwise known as ‘minerals’ in nutrition science) iron, zinc, copper, manganese, magnesium, selenium, chromium are needed for many body functions, and are required by the body in sufficient quantities to meet its demands in order to maintain optimum health. These minerals are found in varying levels in different foods according to the source (i.e., magnesium from cereal products, iron and zinc from red animal muscle tissue, etc.) and production location (i.e. high or low selenium soils) of that product. Economic, religious and ethical constraints, or simple personal food preferences, may result in certain populations or individuals consuming a diet that does not provide adequate levels of certain essential minerals for optimum health.

Fortification technologies provide opportunities to add an essential mineral(s) to products that would not usually be significant sources of the mineral(s). This means that a wider range of food products can contribute to the total dietary intake of the mineral(s), and thus provides consumers with alternative means of achieving the intakes required for optimum health. However, addition of minerals to foods can be technologically challenging, especially minerals that tend to readily interact with other food components, such as iron. This challenge is particularly difficult in liquid food formats, where processing steps such as heating are involved. At present, fortifying foods or beverages with a physiologically-relevant level of bioavailable iron without the development of undesirable taste (metallic) and appearance (colour changes which can occur either during processing or storage) is a significant challenge.

The natural forms of iron in the diet are haem and non-haem. Haem iron is a constituent of haemoglobin, the molecule that is responsible for carrying oxygen in the blood of most animals. For this reason, it is solely of animal origin, and is found in significant levels in meats such as beef, lamb and pork. It is highly bioavailable, due to its solubility in the alkaline conditions of the duodenum and jejunum (West and Oates, 2008), which allows it to be readily absorbed by the body. However, despite its high bioavailability, its animal origin presents difficulties for vegetarian and vegan populations.

Non-haem iron is naturally found in plant sources in either the ferrous or ferric form, and has a lower bioavailability due to low solubility at intestinal pH. The ferrous form of iron can be easily oxidized to its ferric state in the presence of oxygen, as is commonly encountered under processing conditions. Ferric salts of iron are precipitated as ferric hydroxide at pH >3, making them unavailable for absorption in the duodenum (Conrad and Umbreit, 2002).

The general dilemma in iron fortification of liquid and semi-solid foods (especially milk and dairy products) has been the issue of product stability. Traditional fortificants like ferrous sulphate or elemental iron are not suitable for the mass iron fortification of a range of food products due to lack of physico-chemical compatibility. Nutritional programs involving iron fortification, that target young children and women, have attempted to fortify milk and dairy products due to their high nutritional value.

However, the reactivity of soluble (bioavailable) iron sources with constituents in liquid milk (caseins, fat and calcium in milk) has been shown to decrease the bioavailability of iron both in vitro and in vivo in the past (Edmondson, 1971). Reactivity of the iron sources also can translate into unpalatable products which is a further disadvantage. This reason has been the main deterrent in using milk as a vehicle for iron fortification.

The general consensus is that greater bioavailability is found in iron ingredients which have increased solubility at the duodenal pH (i.e. ferrous sulfate at pH 6.6-6.9) but at the same time strong interactions with the product matrix. Compounds like ferric pyrophosphate, which are poorly soluble, have been used for fortification of dried milk and dairy products as they do not interfere with the product matrix. However, its reported bioavailability is highly variable and overall significantly lower than of ferrous sulfate (Hurrell, 2002).

Chelated forms of iron have emerged as a convenient choice, as they are soluble at a physiological pH and are therefore available for absorption within the body. As the iron is bound to a ligand, its interaction with other compounds are greatly reduced present in the food matrix. However, despite their benefits from a functional and bioavailability perspective, chelates such as sodium ferredetate and ferrous bisglycinate are not presently used as a mass fortificant because of their reactivity at high temperatures (especially in the presence of polyphenols), as well as a high cost of raw materials.

### SUMMARY

The present disclosure provides a method of in-situ complexation of an exogenous mineral with milk casein in liquid form for fortification in a dairy product with increased bioavailability of the exogenous mineral.

The method comprises: adding exogenous phosphorus and the exogenous mineral to at least one material to form a composition comprising a soluble complex, the at least one material selected from the group consisting of (i) a milk comprising the milk casein, wherein the milk casein is in a micellar structure from a mammal, (ii) a milk derivative comprising the milk casein, wherein the milk casein is in a micellar structure from a mammal, (iii) a casein isolate comprising the milk casein, and (iv) a casein concentrate comprising the milk casein. At least one additional ingredient is present during the adding of the exogenous phosphorus and the exogenous mineral to the at least one material to form the composition comprising the soluble complex. The soluble complex comprises (i) at least a portion of the exogenous mineral, (ii) at least a portion of the milk casein, and (iii) at least a portion of the exogenous phosphorus; and the soluble complex has micellar structure.

The exogenous phosphorus and the exogenous mineral are preferably added to the casein-containing composition at pH 6.5-7.3 and at a temperature from 5 to 70° C., preferably 5° C. to 25° C., more preferably 8° C. to 25° C., even more preferably 8° C. to 15° C.

The at least one additional ingredient preferably comprises at least one of a lipid, a vitamin or a mineral, more preferably at least one of Vitamin C, Vitamin D, Vitamin A, Vitamin E, calcium, zinc or magnesium.

The method preferably does not include prolonged stirring the composition after the adding of the exogenous phosphorus and the exogenous mineral to the at least one material, or the method comprises stirring the composition less than thirty minutes, such as less than twenty-five minutes, less than twenty minutes, less than fifteen minutes, less than ten minutes or less than five minutes. In one embodiment the stirring may be a gentle mixing.

The method preferably does not include a clarification step after the adding of the exogenous phosphorus and the exogenous mineral to the at least one material, and more preferably the method does not include any clarification step.

The present disclosure also provides a composition made by these methods. A non-limiting example of such a composition comprises calcium, a mineral, and protein, the protein comprising whey and casein, the composition comprising a soluble complex, the complex comprising (i) at least a portion of the casein, (ii) at least a portion of the mineral and (iii) phosphorus, wherein the composition has a weight ratio of the protein to the calcium less than 45:1, preferably between 40:1 and 10:1, most preferably between 35:1 and 20:1.

An advantage of one or more embodiments provided by the present disclosure is to perform mineral-protein complexation without a heating-cooling-heating cycle.

Furthermore, an advantage of one or more embodiments provided by the present disclosure is to use milk as a starting material which thereby establishes the desired pH without the need for a pH adjusting agent or a buffer.

Yet further, an advantage of one or more embodiments provided by the present disclosure is to achieve mineral-protein complexation using less processing steps.

Still further, an advantage of one or more embodiments provided by the present disclosure is to include other ingredients of a final product, such as vitamins and additional minerals, during mineral-protein complexation so that the other ingredients do not need to be added to the complex after complexation.

Moreover, an advantage of one or more embodiments provided by the present disclosure is mineral fortification without altering the sensory attributes of the product.

Another advantage of one or more embodiments provided by the present disclosure is increased mineral bioavailability.

Furthermore, an advantage of one or more embodiments provided by the present disclosure is to form a mineral-protein complex at higher temperatures than known methods to thereby achieve energy and time savings (e.g., less cooling after heating).

Yet further, an advantage of one or more embodiments provided by the present disclosure is to use a dilute system to achieve mineral-protein complexation and thereby minimize or avoid specific equipment.

Additional features and advantages are described herein and will be apparent from the following Figures and Detailed Description.

### BRIEF DESCRIPTION OF DRAWINGS

FIG. 1 is a flowchart of an example method of in-situ complexation of an exogenous mineral with milk casein in liquid form for fortification in a dairy product with increased bioavailability of the exogenous mineral, according to an embodiment provided by the present disclosure.

FIG. 2 is a graph showing in vitro iron bioaccessibility in a validated CaCo2 cell model.

FIGS. 3 and 4 are graphs showing photographs from Example 4 disclosed herein.

FIGS. 5A and 5B are graphs showing analysis of the permeate by size exclusion chromatography from Example 4 disclosed herein.

FIG. 6 is a chromatographic profile of soluble complex by size exclusion chromatography (SEC) with UV detection

FIG. 7 is a graph showing the input sample of soluble complex Sample 1 indicating iron is bound in a 3-component soluble complexes (in protein aggregates, proteins and peptides fractions)

FIG. 8 is a graph showing the input sample of soluble complex Sample 2 indicating iron is bound in a 3-component soluble complexes (in protein aggregates, proteins and peptides fractions).

FIG. 9 is a graph showing the flowthrough (F/T) sample of soluble complex Sample 1 indicating iron is bound in a 3-component soluble complexes (in peptides fraction only).

FIG. 10 is a graph showing the flowthrough (F/T) sample of soluble complex Sample 2 indicating iron is bound in a 3-component soluble complexes (in peptides fraction only).

FIG. 11 is a graph showing shows stable colour of soluble complex at increasing iron concentration

FIG. 12 is a chart that shows dairy products containing soluble complex having a similar or better iron bioaccessibility compared to Dairy standard (full cream milk powder containing ferrous sulfate) and Dairy reference (full cream milk powder containing ferric pyrophosphate).

FIG. 13 is a chart that shows hybrid powder (contains full cream milk powder, soy flour, soy lecithin) containing soluble complex having a similar or better iron bioavailability compared to Hybrid standard (hybrid powder containing ferrous sulfate) and Hybrid reference (hyrid powder containing ferric pyrophosphate).

FIG. 14 is a chart that shows cocoa milk drink with soluble complex having a similar or better iron bioavailability compared to standard cocoa milk drink (containing ferrous sulfate).

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

As used in this disclosure and the appended claims, the singular forms “a,” “an” and “the” include plural referents unless the context clearly dictates otherwise. Thus, for example, reference to “a mineral” or “the mineral” encompass both an embodiment having a single mineral and an embodiment having two or more minerals.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified.

The terms “at least one of” and “and/or” used in the respective context of “at least one of X or Y” and “X and/or Y” should be interpreted as “X,” or “Y,” or “X and Y.” For example, “at least one of a vitamin or mineral” and “vitamin and/or mineral” should be interpreted as “vitamin without mineral,” or “mineral without vitamin,” or “both vitamin and mineral.”

Where used herein, the terms “example” and “such as,” particularly when followed by a listing of terms, are merely exemplary and illustrative and should not be deemed to be exclusive or comprehensive. As used herein, a condition “associated with” or “linked with” another condition means the conditions occur concurrently, preferably means that the conditions are caused by the same underlying condition, and most preferably means that one of the identified conditions is caused by the other identified condition.

A “subject” or “individual” is a mammal, preferably a human.

All percentages expressed herein are by weight of the total weight of the composition unless expressed otherwise. As used herein, “about” or “approximately” refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number.

### Embodiments

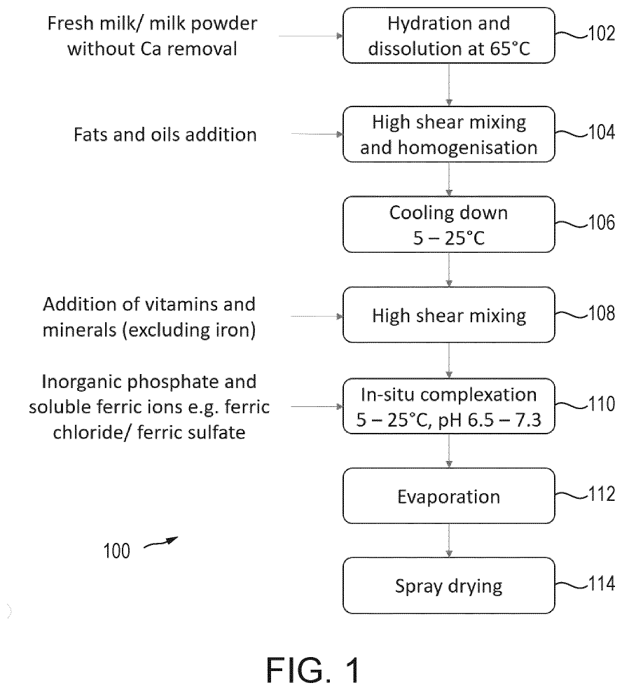

FIG. 1 generally illustrates a non-limiting embodiment of a method 100 of in-situ complexation of an exogenous mineral with milk casein in liquid form for fortification in a dairy product with increased bioavailability of the exogenous mineral. The dairy product is preferably formulated for oral administration to an individual, for example as a beverage. In some embodiments, the method 100 can omit one or more steps shown in the figure and/or can include one or more additional steps beyond those shown in the figure; and the methods disclosed herein are not limited to the specific embodiments shown in the figure.

In Step 102, at least one material comprising the milk casein can be subjected to hydration and dissolution, for example at a heated temperature above room temperature, such as 95° C. The at least one material comprising the milk casein can be a mammalian milk in liquid or powder form and which has not undergone calcium removal and does not undergo calcium removal.

Preferably the at least one material does not include any caseinate. In some embodiments, the at least one material comprising the milk casein is selected from the group consisting of (i) a milk comprising the milk casein, wherein the milk casein is in a micellar structure from a mammal, (ii) a milk derivative comprising the milk casein, wherein the milk casein is in a micellar structure from a mammal, (iii) a casein isolate comprising the milk casein, and (iv) a casein concentrate comprising the milk casein. Preferably, the at least one material is selected from the group consisting of whole milk, skim milk, low lactose milk, ultrafiltration retentate, concentrated milk, and mixtures thereof.

In some embodiments, the at least one material is a milk comprising the milk casein; the milk comprising protein and calcium; the protein comprising whey and the milk casein; and the milk has a weight ratio of the protein to the calcium less than 45:1, preferably between 40:1 and 10:1, more preferably between 35:1 and 25:1, most preferably 30:1.

In Step 104, the composition obtained by Step 102 can be subjected to high shear mixing and homogenization. In some embodiments, at least one of a fat or an oil is added to the composition obtained by Step 102 before and/or during the high shear mixing and homogenization thereof.

In Step 106, the composition obtained by Step 104 can be cooled to a lower temperature after being subjected to the high shear mixing and homogenization, for example cooled to a temperature from 5° C. to 25° C., preferably 8° C. to 25° C., more preferably 8° C. to 15° C.

In Step 108, the composition obtained by Step 106 can be subjected to high shear mixing. In preferred embodiments, at least one additional ingredient is added to the composition obtained by Step 106 before and/or during the high shear mixing thereof, for example at least one of a lipid, a vitamin, or a non-iron mineral, preferably at least one of Vitamin C, Vitamin D, Vitamin A, Vitamin E, calcium, zinc or magnesium.

In Step 110, exogenous phosphorus and exogenous mineral are added to the composition obtained by Step 108 to form a complexation composition, for example at pH 6.5-7.3 and at a temperature from 5° C. to 70° C., preferably from 5° C. to 25° C., more preferably 8° C. to 25° C., even more preferably 8° C. to 15° C.

The term “exogenous” means that the phosphorus and mineral are externally added and are not provided endogenously by the material comprising the milk casein.

In some embodiments, the exogenous mineral is iron, which is preferably added as soluble ferric irons such as ferric chloride and/or ferric sulfate. In some embodiments, the exogenous phosphorus is added as inorganic phosphate. Preferably, at least a portion of the exogenous phosphorus is dipotassium phosphate. The at least one additional ingredient (e.g., a lipid, vitamin and/or non-iron mineral, such as Vitamin C, Vitamin D, Vitamin A, Vitamin E, calcium, zinc and/or magnesium) is may be added during the addition of the exogenous phosphorus and the exogenous mineral or afterwards.

In some embodiment, the mineral comprises iron, preferably ferric iron salts and preferably at a concentration of 0.005 wt. % to 1 wt. % of the complexation composition; preferably at a weight ratio of the phosphorous to the iron between 1:1 and 50:1, more preferably between 1:1 and 20:1.

Preferably the complexation composition does not include any caseinate. Preferably the method does not comprise adding a pH regulator to the at least one material, and/or the complexation composition does not comprise a pH regulator.

In some embodiments, the method comprises stirring the complexation composition for a time period less than thirty minutes, for example, less than twenty-five minutes, less than twenty minutes, less than fifteen minutes, less than ten minutes, or less than five minutes. In some embodiments, the method does not include stirring the complexation composition. Such embodiments advantageously avoid the need for a reaction tank. In some embodiments, the method does not include a clarification step after the complexation, and more preferably does not include any clarification step.

The complexation in Step 110 forms a soluble complex comprising (i) at least a portion of the exogenous mineral, (ii) at least a portion of the milk casein, and (iii) at least a portion of the exogenous phosphorus; and the soluble complex has micellar structure. In some embodiments, the exogenous mineral is at least 0.1 wt. % of the soluble complex, preferably at least 1.0 wt. % of the soluble complex.

In Step 112, the composition obtained by Step 110 can be subjected to evaporation. In Step 114, the composition obtained by Step 112 can be subjected to spray drying.

Preferably, the soluble complex is to fortify a product e.g. a nutritional beverage product, a food product, a therapeutic/pharmaceutical composition or an animal feed composition. In some embodiment of the invention, the mineral-protein complex integrated in food and beverage products in-situ, or used as the base for any product to be consumed orally, in order to provide a source of an essential mineral. A wide range of mineral (e.g., iron) fortification in beverages is possible without affecting taste, color and shelf-life.

It has been found that the composition according to the invention and as described herein have soluble complexes that has in-vitro bioavailability equal to or 100-200% higher in relative bioavailability than ferrous sulfate. It has furthermore been found that the soluble complexes are particularly beneficial due to good bioavailability, minimal impact sensory (e.g. texture). Furthermore, soluble complexes allow a good processability compared to non-soluble complexes or non-soluble iron sources.

### EXAMPLES

The following non-limiting examples support the inventive concepts disclosed herein.

### Example 1: Influence of Casein Iron Complexes on Sensory of Fortified Milk Powder Containing Iron

Fortified milk powder containing iron, calcium, vitamin A, vitamin D3 and vitamin C was prepared with a standard milk processing procedure. Specifically, fresh milk and skimmed milk powder were dissolved at 60° C.-65° C., emulsified with vegetable oils and cooled down to 10° C.-25° C. prior to the addition of vitamins and minerals. The milk emulsion was further concentrated by two-effect evaporation followed by spray drying. The resultant fortified milk powder is stored in sealed packaging at ambient shelf life (25° C.-30° C.). Two types of fortified milk powder were prepared: milk powder containing ferric pyrophosphate (reference) and milk powder containing in situ complexation of casein iron and phosphate. Ferric pyrophosphate is an insoluble iron source (at neutral pH) and was chosen as a reference due to its minimal interaction with sensitive ingredients e.g. oils and vitamins resulting in a neutral sensory (no off note).

Sensory attributes and off-notes such as metallic and rancidity were evaluated by an experienced panel (>6 people) on a scale from 0 to 5 (0: no difference to reference/no off note, 1: just noticeable off-note, 2: slight off-note, 3: slight definite off-note, 4: definite off-note, 5: definite strong off-note). A sample having a sensory score of 4 or higher was considered as unacceptable. 4 months shelf life (25° C.-30° C.) shows that there is no difference with reference and no off-note was found. This shows that the in-situ iron casein complex preparation has the same sensory performance as ferric pyrophosphate (reference).

| Storage time (months) | 1 | 2 | 3 | 4 |
|---|---|---|---|---|
| Fortified milk powder containing ferric | 0 | 0 | 0 | 0 |
| pyrophosphate (Reference) | | | | |
| Fortified milk powder containing casein | 0 | 0 | 0 | 0 |
| iron complexes | | | | |

### Example 2: In-Vitro Iron Bioaccessibility of Casein Iron Complexes in Comparison to Ferrous Sulfate (Golden Standard) and Ferric Pyrophosphate

Iron deficiency remains a major global health problem affecting an estimated 2 billion people. Highly soluble compounds of iron, such as ferrous sulfate (relative bioavailability 100%), are desirable food fortificants but cannot be used in many food vehicles because of sensory issues. Thus, potentially less well-absorbed forms of iron commonly are used in food fortification e.g. Iron pyrophosphate (Hurrell et al., Int J Vitam Nutr Res. 2004 Nov; 74(6) 387-40).

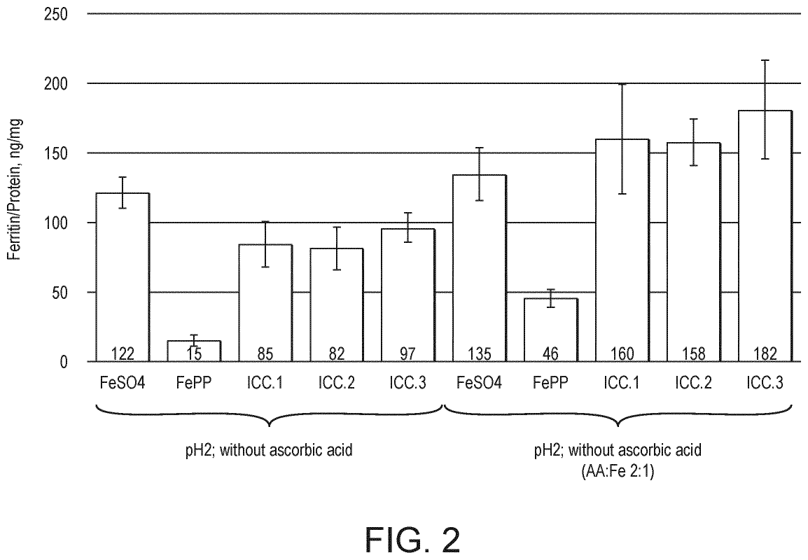

FIG. 2 shows in vitro iron bioaccessibility (validated CaCo2 cell model); Glahn et al. Cornell University, February 2021, unpublished. The in-situ casein-iron complexes according to the present disclosure (three batches presented and labelled as ICC in FIG. 2) is shown to have a similar in-vitro bioaccessibility as ferrous sulfate (FeSO4) and much higher than ferric pyrophosphate (FePP) without the presence and with the presence of ascorbic acid (a known element to enhance the absorption of fortification iron). The in-situ casein-iron complexes according to the present disclosure allow the combination of similar bioavailability as ferrous sulfate without the expense of sensory deviation.

### Example 3: Iron in Casein-Iron Complexes Exists in a Chelated Form, with No Ionic or Diffusible Iron (e.g. Fe2+ or Fe3+) Evidenced by Reagent Test, Ultrafiltration and Size Exclusion Chromatography

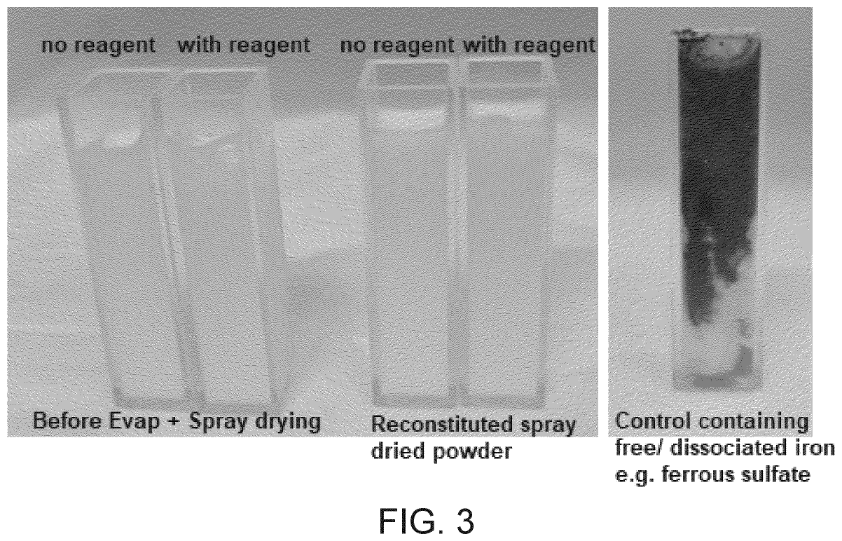

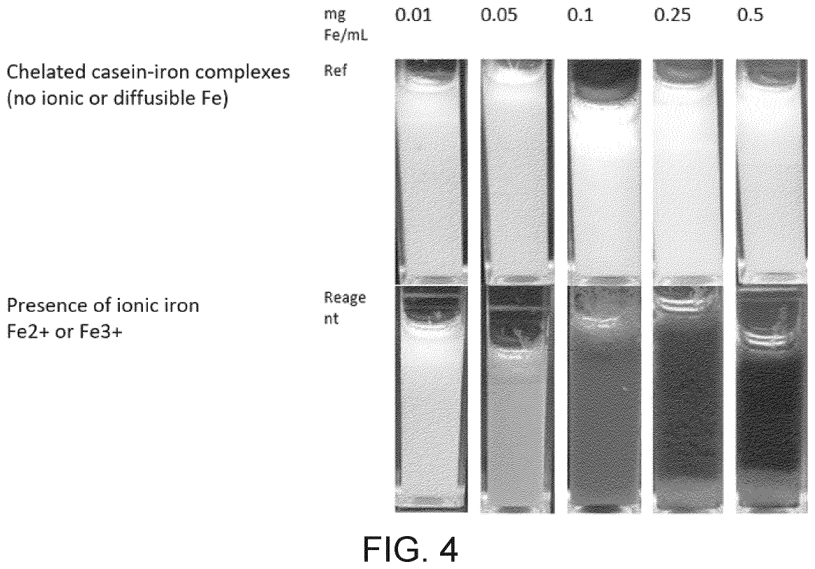

As shown in FIGS. 3 and 4, fortified milk with in-situ casein-iron complexes was evaluated with 0.1 M potassium ferricyanide K₃[Fe(CN)₆]. Potassium ferricyanide is more commonly used as a confirmatory test for the presence of ferrous or ferric ions which will be shown by dark blue or brown coloration. In this case, a few drops of 0.1M K₃[Fe(CN)₆] were added to fortified milk containing casein iron complexes prior to evaporation and spray drying and in reconstituted spray dried milk powder. No coloration was observed, which shows all iron was complexed/chelated. As a control, milk containing ferrous sulfate was added with a few drops of 0.1M K₃[Fe(CN)₆], which resulted in dark blue coloration.

Casein-iron complexes were also characterized by ultrafiltration. Specifically, 26 g of fortified milk powder containing casein-iron complexes was reconstituted with 180 ml 40° C. pure water. The solution is filled into an ulftrafiltration tube with 10 kDa pore size (Macrosep Advance centrifugal device with Supor Membrane) followed by centrifugation (Beckman Coultre fixed angle Rotor JA-30.50) at 500 G at 20 ° C. for 45 minutes. The permeate was collected without dilution and subjected to ICP-AES analysis of iron content. The content of iron in the permeate was between 0-1 mg Fe/100 g (representing up to 5% of total iron content).

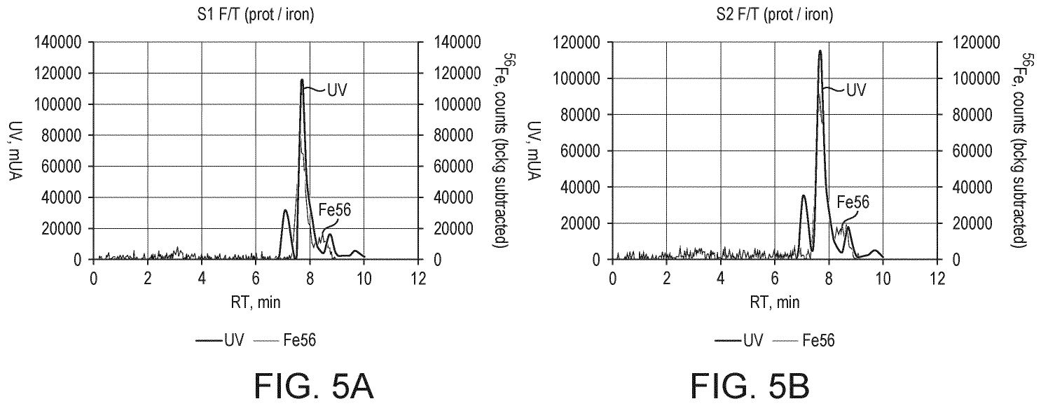

As shown in FIGS. 5A and 5B, the permeate was analyzed by separation using size exclusion chromatography. Elution followed by detection of proteins and iron was conducted to see if the iron present in the flow-through is free or associated with a protein/peptide fraction. The figures show that iron found in the flow-through (permeate) after 10 kDa ultrafiltration was bound to protein fractions/polypeptides. The large majority of iron was bound to protein aggregates in the retentate part and the iron in the retentate was bound to protein aggregates.

### Example 4: Characterization of Soluble Complexes (Casein-Iron Complexes)

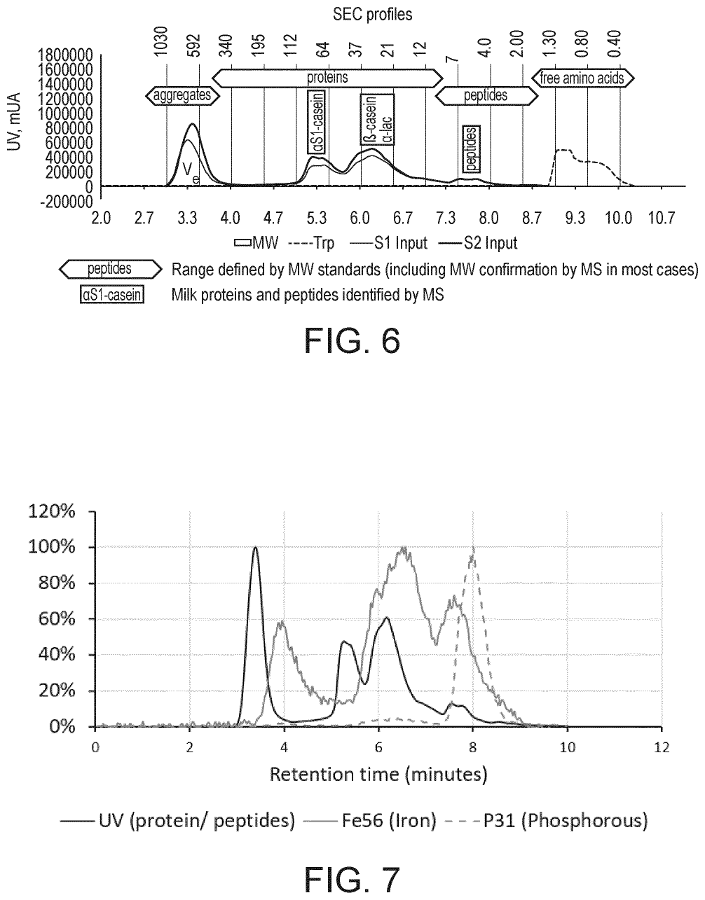

FIG. 6 shows the chromatography profile of the soluble complex (by Size Exclusion Chromatography with UV detector). In FIG. 6 S1 (or Sample 1) is a soluble complex containing 2.5 mM iron and S2 (or Sample 2) is a soluble complex containing 1.9 mM iron The soluble complex is characterized by the co-elution of proteins and peptides and iron and phosphate in both the input fraction (before 10 kDa ultrafiltration) and the flowthrough fraction (F/T) (after 10 kDa ultrafiltration) by Size Exclusion Chromatography.

Samples were suspended to 1% (w/w) protein in 40° C. milliQ water and centrifuged through a 10-kDa cutoff filter at 5000× g at 20° C. during 45 min. Input and flow-through (F/T) fractions were adjusted to 50 mM ammonium acetate and centrifuged at 16000× g for 10 min at room temperature. The cleared supernatants were analyzed by native size exclusions chromatography on two different instruments using the same column, buffer. Protein aggregates, proteins and peptides were detected by UV. Iron and phosphorous were measured by elemental ICP-MS. Under those chromatographic conditions, protein aggregates elute between 2.5 and 3.5 minutes, proteins between 3.5 and 7.0 minutes, peptides between 7 and 8.5 minutes. Free amino acids and free iron elute between 8.5 and 10.5 minutes.

FIG. 7 shows that protein aggregates, proteins, and peptides were all detected in the input sample of soluble complex Sample 1. Iron and Phosphorus were associated with all three regions, indicating that iron in bound in a 3-component soluble complexes. Y-axis shows normalized value (normalization to maximum value).

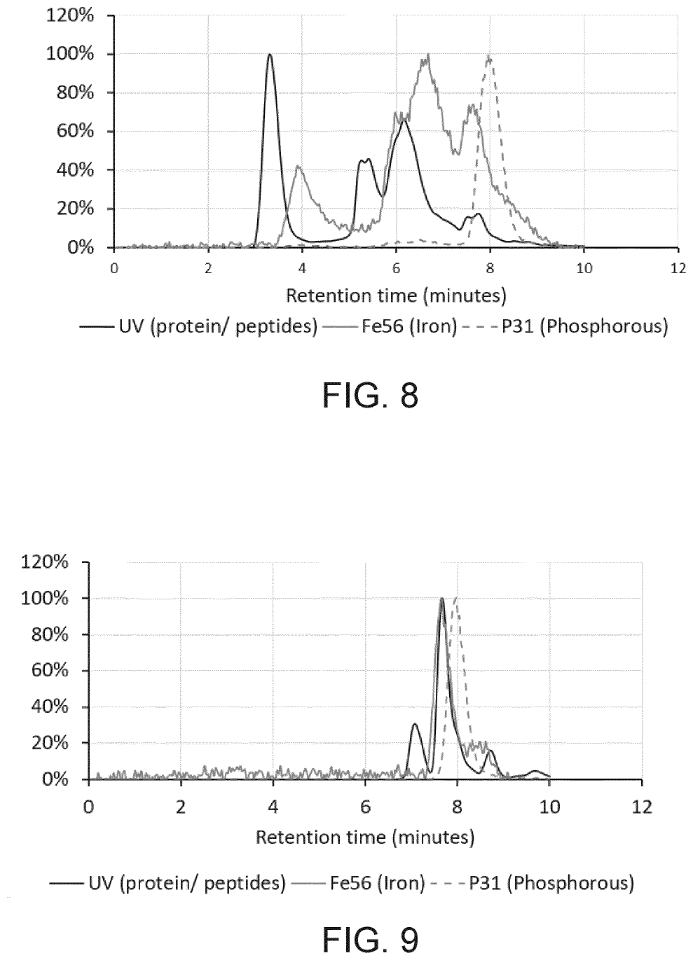

FIG. 8 shows that protein aggregates, proteins, and peptides were all detected in the input sample of soluble complex Sample 2. Iron and Phosphorus were associated with all three regions, indicating iron is bound in 3-component soluble complexes. Y-axis shows normalized value (normalization to maximum value).

Furthermore in FIG. 9 we see that only peptides were detected in the flow-through samples of soluble complex Sample 1. Peptides, iron and phosphorus co-eluted, indicating iron is bound in a 3-component soluble complex in the flow-through sample. Y-axis shows normalized value (normalization to maximum value).

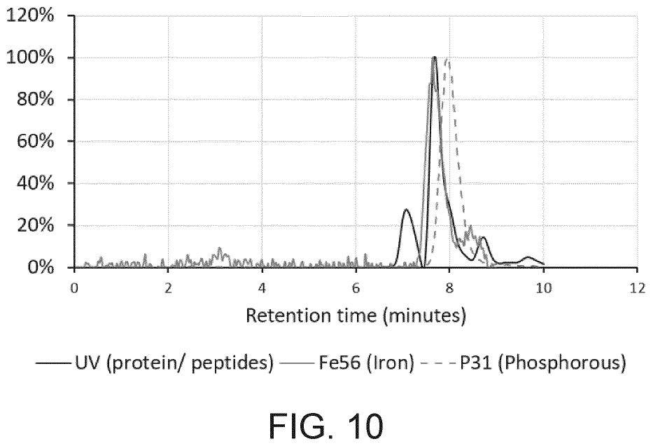

Furthermore in FIG. 10 we see that only peptides were detected in the flow-through samples of soluble complex Sample 2. Peptides, iron and phosphorus co-eluted, indicating iron is bound in a 3-component soluble complex in the flow-through sample. Y-axis shows normalized value (normalization to maximum value).

Elemental speciation analysis confirmed that this iron from the F/T is eluting before free ionic iron. Molecular speciation analysis confirmed that the retention time observed for the soluble complex flowthrough (F/T) is inside the peptide region, suggesting that the iron detected are likely bound to small peptides. Altogether, this shows that the iron found in the F/T after 10 kDa ultrafiltration is bound to polypeptides.

Table 1 shows the soluble complex being characterised by low concentration (<1 mg Fe/100 g) of diffusible iron in 12.5% (w/w) solution of milk or casein containing iron. Diffusible iron is here defined as the quantity of iron measured by ICP-MS as permeate (or flowthrough) of 10 kDa ultrafiltration.

| Product | Fe (mg/100 g) |
|---|---|
| Soluble complex Batch 1 | 0.16 |
| Soluble complex Batch 2 | 0.17 |
| Soluble complex Batch 3 | 0.16 |
| Soluble complex Batch 4 | 0.16 |
| Soluble complex Batch 5 | 0.15 |
| Soluble complex Batch 6 | 0.16 |

### Example 5: Colour and Sensory Stability of Soluble Complexes (Casein-Iron Complexes)

The soluble complex has a beige colour similar to milk and no difference in colour (no darkening/yellowing) was observed with increasing iron concentration.

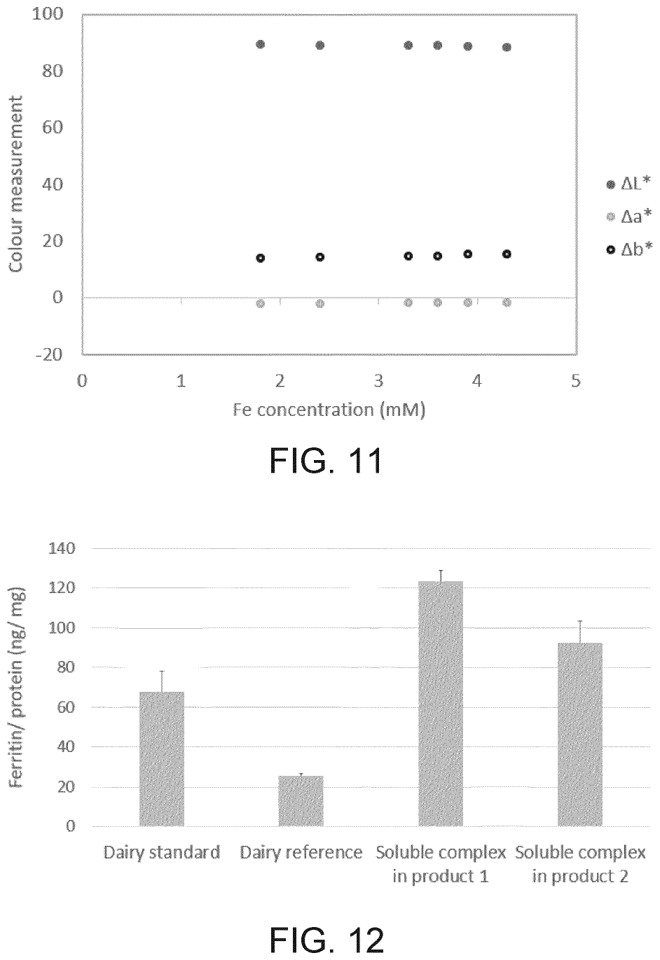

FIG. 11 shows stable colour of soluble complex at increasing iron concentration. The colour was evaluated in triplicate for each sample through the L* a* b* parameters using a colorimeter. L* is the colour lightness (L*=0 for black and L*=100 for white), a* is green (−)/red (+) axis, and b* is the blue (−)/yellow (+) axis. ΔL*, Δa* and Δb* were calculated from the difference between the sample values and controls.

Table 2 shows that the soluble complex has the advantage of no significant change in sensory profile (no off-flavour development) during product stability study at 30° C. for 12 months. The evaluated sensory modalities are appearance, flavours and texture. The scoring system is based on the Degree of Difference (DoD) to the reference sample strorage at 4° C. Value below 1 is considered no significant difference to the reference.

| Storage | | | |
|---|---|---|---|
| conditions | Apperance | Flavours | Texture |
| 3 months/30° C. | 0 | 0.5 | 0 |
| 6 months/30° C. | 0 | 0.5 | 0 |
| 9 months/30° C. | 0 | 0.3 | 0 |
| 12 months/30° C. | 0 | 0.5 | 0 |

Degree of Difference (DoD):
0 = no difference
1 = just a little difference
2 = slight difference
3 = clear difference
4 = much difference
5 = very much difference

### Example 6: In-Vitro Bioavailability of Soluble Complexes in Different Product Matrices

The soluble complex is characterised by in-vitro bioavailability results (simulated digestion coupled with Caco-2 cell model) showing similar bioavailability when compared to Ferrous sulfate (100% relative bioavailability)

FIG. 12 shows that dairy products containing soluble complex (soluble complex in product 1 and soluble complex in product 2) have similar or better in-vitro bioavailability when compared to Dairy standard (full fat milk powder containing ferrous sulfate) and Dairy reference (full fat milk powder containing ferric pyrophosphate).

Product 1 is a milk powder containing milk solids, vegetable fats, glucose syrup, sugar, soy lecithin, stabilizer, minerals and vitamins and soluble complex. Iron concentration is 11.5 mg/100 g powder. It has nutritional values as follow: Protein: 14.5 g Fat: 20 g Carbohydrates 55 g

Product 2 is a milk powder containing milk solids including milk fat; vegetable fats, soy lecithin; minerals and vitamins and soluble complex. Iron concentration is 9 mg/100 g powder. It has nutritional values as follow: Protein: 23 g Fat: 28 g Carbohydrates 37.5 g

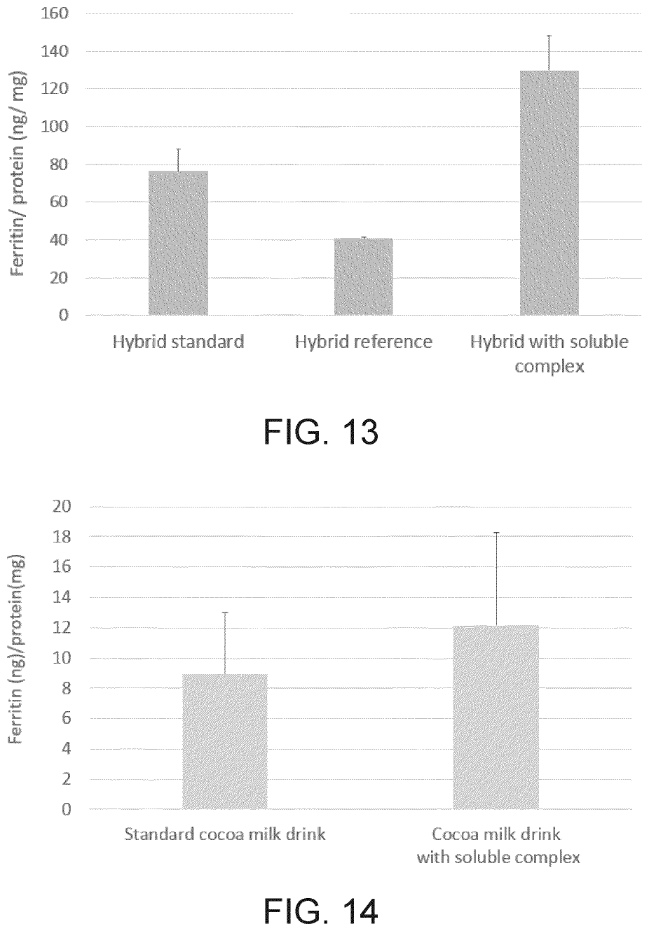

FIG. 13 shows Hybrid with soluble complex (hybrid powder containing soluble complex) with similar or better iron bioavailability when compared to Hybrid standard (hybrid powder containing ferrous sulfate) and Hybrid reference (hybrid powder containing ferric pyrophosphate). Hybrid powder is composed of full cream milk powder, soy flour and soy lecithin.

Hybrid standard, Hybrid reference and Hybrid with soluble complex contain iron 12.7 mg/100 g powder and has the following nutritional values: Protein: 31.9 g Fat: 23.2 g; Carbohydrates 26.3 g; Fiber 7.9 g

FIG. 14 shows chocolate milk drink containing soluble iron complex with similar or better iron bioavailability when compared with Standard cocoa milk drink (cocoa milk drink containing ferrous sulfate). Chocolate milk drink is composed of milk, sugar, vegetable oil and cocoa powder. Protein: 2.3 g Fat: 1.1 g; Carbohydrates 8.7. Iron content is 3 mg/100 g.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of in-situ complexation of an exogenous mineral with milk casein in liquid form for fortification in a dairy product with increased bioavailability of the exogenous mineral, the method comprising:
adding exogenous phosphorus and the exogenous mineral to at least one material to form a composition comprising a soluble complex, the at least one material selected from the group consisting of a milk comprising the milk casein, wherein the milk casein is in a micellar structure from a mammal, a milk derivative comprising the milk casein, wherein the milk casein is in a micellar structure from a mammal, a casein isolate comprising the milk casein, and (iv) a casein concentrate comprising the milk casein,
wherein at least one additional ingredient is present during the adding of the exogenous phosphorus and the exogenous mineral to the at least one material to form the composition comprising the soluble complex, and
wherein the soluble complex comprises at least a portion of the exogenous mineral, at least a portion of the milk casein, and at least a portion of the exogenous phosphorus, and wherein the soluble complex has micellar structure.

2. The method of claim 1, wherein the at least one material to which the exogenous phosphorus and the exogenous mineral are added is a milk comprising the milk casein, the milk comprising protein and calcium, the protein comprising whey and the milk casein, the milk has a weight ratio of the protein to the calcium less than 45:1.

3. The method of claim 1, wherein the composition does not comprise any caseinate.

4. The method of claim 1, wherein the method does not comprise adding a pH regulator to the at least one material, and the composition does not comprise a pH regulator.

5. The method of claim 1, wherein the at least one material is selected from the group consisting of whole milk, skim milk, low lactose milk, ultrafiltration retentate, concentrated milk, and mixtures thereof.

6. The method of claim 1, wherein at least a portion of the exogenous phosphorus is added to the at least one material by adding dipotassium phosphate to the at least one material.

7. The method of claim 1, wherein the mineral comprises iron.

8. (canceled)

9. A composition comprising calcium, a mineral, and protein, the protein comprising whey and casein, the composition comprising a soluble complex, the complex comprising at least a portion of the casein, at least a portion of the mineral and phosphorus,
wherein the composition has a weight ratio of the protein to the calcium less than 45:1.

10. The composition of claim 9, wherein the casein is in the form found in milk.

11. The composition of claim 9, wherein the composition does not comprise any caseinate.

12. The composition of claim 9, wherein the composition does not comprise a pH regulator.

13. The composition of claim 9, comprising a milk from a mammal, wherein the milk comprises at least a portion of the whey and at least a portion of the casein and is selected from the group consisting of whole milk, skim milk, low lactose milk, ultrafiltration retentate concentrated milk, and mixtures thereof.

14. The composition of claim 9, comprising inorganic phosphate such as dipotassium phosphate, the dipotassium phosphate comprising at least a portion of the phosphorus.

15. The composition of claim 9, wherein the mineral comprises iron, preferably ferric iron; preferably at a weight ratio of the phosphorous to the iron between 5:1 and 70:1.

16. The composition according to claim 9, wherein the soluble complexes in the composition has in-vitro bioavailability equal to or 100-200% higher in relative bioavailability than ferrous sulfate.
